(19) United States
(12) Patent Application Publication
(10) Pub. No.: US 2018/0322908 A1
(43) Pub. Date: Nov. 8, 2018

(54) METHOD FOR GIVING DYNAMIC EFFECT TO VIDEO AND ELECTRONIC DEVICE THEREOF

(71) Applicant: SAMSUNG ELECTRONICS CO., LTD., Suwon-si (KR)

(72) Inventors: Moojung KIM, Seongnam-si (KR); Daehee KIM, Suwon-si (KR); Seunghee LEE, Hwaseong-si (KR); Dae-Kyu SHIN, Suwon-si (KR)

(21) Appl. No.: 15/966,338

(22) Filed: Apr. 30, 2018

(30) Foreign Application Priority Data
May 2, 2017 (KR) 10-2017-0056229

(51) Int. Cl. G11B 27/036; G06K 9/00; G11B 27/30

(52) U.S. Cl. CPC G11B 27/036; G06K 9/00221; G11B 27/3081; G06K 9/00744

(57) ABSTRACT

Various embodiments of the present disclosure relate to an apparatus and method for applying a dynamic effect to a picture in an electronic device. The electronic device may include a memory for storing one or more image frames, a display, and a processor. The processor may be configured to identify an amount of change between the one or more image frames, to determine a partial region from an entire region of at least one image frame detected based on the amount of change among the one or more image frames, to determine a playback mode corresponding to the partial region, and to display the partial region based on at least the playback mode using the display.

### CROSS REFERENCE TO RELATED APPLICATION

This application is based on and claims priority under 35 U.S.C. § 119 to Korean Patent Application No. 10-2017-0056229, filed on May 2, 2017, in the Korean Intellectual Property Office, the disclosure of which is incorporated by reference herein in its entirety.

### BACKGROUND

### Field

The present disclosure relates to an apparatus and method for applying a dynamic effect to a picture in an electronic device.

### Description of Related Art

With the advance of information communication techniques and semiconductor techniques, electronic devices are being developed into multimedia devices for providing various multimedia services. For example, the multimedia service may include at least one of a voice call service, a message service, a broadcasting service, a wireless Internet service, a camera service, a picture playback service, and a music playback service.

The electronic device may provide a picture service for playing back a video file. For example, the electronic device may capture a picture through a camera, or store at least one video file received from an external device. The electronic device may play back a video file selected by a user among the at least one video file.

### SUMMARY

When a video file is played back, an electronic device may play back the video file by decoding picture and audio signals included in the video file. For example, the electronic device may decode a image frame (or a picture signal) of the video file through a video decoder, and may interpret an audio signal of the video file through an audio decoder. The electronic device may play back the video file by synchronizing the decoded picture and audio signals. In this case, the electronic device plays back the video file by simply decoding the video file. Therefore, in case of a monotonous video file having a small change between frames, it is difficult to make a user get interested, which may result in a problem in that accessibility of the video file is decreased. For example, the accessibility of the video file may include how frequently the video file is played back.

Various embodiments of the present disclosure provide an apparatus and method for providing a dynamic effect to a still picture, when the picture is played back in an electronic device.

According to various embodiments of the present disclosure, an electronic device may include a memory, a display, and a processor. The processor may be configured to identify an amount of change between one or more image frames stored in the memory, to detect at least one image frame among the one or more image frames based on the amount of change, to determine a partial region from an entire region of the at least one image frame, to determine a playback mode corresponding to the partial region, and to display the partial region based on the playback mode using the display.

According to various embodiments of the present disclosure, a method of operating an electronic device may include identifying an amount of change between one or more images stored in a memory electrically coupled to the electronic device, detecting at least one image frame among the one or more image frames based on the amount of change, determining a partial region from an entire region of the at least one image frame, determining a playback mode corresponding to the partial region, and displaying the partial region based on the playback mode.

According to various embodiments of the present disclosure, an electronic device may include a memory, a display, and a processor. The processor may be configured to determine a partial region in one or more image frames stored in the memory, to identify an amount of change in the partial region between the one or more image frames, to detect at least one image frame among the one or more image frames based on the amount of change, to determine a playback mode corresponding to the partial region of the at least one image frame, and to display the partial region based on the playback mode using the display.

### BRIEF DESCRIPTION OF THE DRAWINGS

The above and other aspects, features and attendant advantages of certain embodiments of the present disclosure will be more apparent from the following detailed description, taken in conjunction with the accompanying drawings, in which:

FIG. 1A is a diagram illustrating an electronic device in a network environment according to various embodiments of the present disclosure;

FIG. 1B is a block diagram illustrating a processor for applying a dynamic effect in an electronic device according to various embodiments of the present disclosure;

FIG. 2 is a block diagram illustrating an electronic device according to various embodiments of the present disclosure;

FIG. 3 is a block diagram illustrating a program module according to various embodiments of the present disclosure;

FIG. 4 is a diagram illustrating a structure for applying a dynamic effect when a picture is played back in an electronic device according to various embodiments of the present disclosure;

FIG. 5 is a flowchart illustrating applying a dynamic effect in an electronic device according to various embodiments of the present disclosure;

FIG. 6 is a flowchart illustrating setting a static interval in an electronic device according to various embodiments of the present disclosure;

FIG. 7 is a flowchart illustrating applying a dynamic effect when a picture is played back in an electronic device according to various embodiments of the present disclosure;

FIGS. 8A, 8B, 8C and FIG. 8D are diagrams illustrating screen configurations for applying a dynamic effect in an electronic device according to various embodiments of the present disclosure;

FIG. 9 is a flowchart illustrating determining a playback mode of a static interval in an electronic device according to various embodiments of the present disclosure;

FIG. 10 is a flowchart illustrating applying a dynamic effect based on a playback mode in an electronic device according to various embodiments of the present disclosure;

FIG. 11 is a state transition diagram illustrating transitioning a playback mode applicable to a static interval in an electronic device according to various embodiments of the present disclosure;

FIG. 12 is a flowchart illustrating applying a dynamic effect based on a change amount of a main region in an electronic device according to various embodiments of the present disclosure; and

FIG. 13 is a flowchart illustrating setting a static interval based on a change amount of a main region in an electronic device according to various embodiments of the present disclosure.

### DETAILED DESCRIPTION

Hereinafter, various example embodiments of the present disclosure are described with reference to the accompanying drawings. It should be understood, however, that it is not intended to limit the various example embodiments of the present disclosure to the particular form disclosed, but, instead, it is intended to cover all modifications, equivalents, and alternatives falling within the spirit and scope of the various example embodiments of the present disclosure. Like reference numerals denote like components throughout the drawings. A singular expression includes a plural concept unless there is a contextually distinctive difference therebetween.

In the present disclosure, an expression “A or B”, “A and/or B”, or the like may include all possible combinations of items enumerated together. Although expressions such as “1^{st}”, “2^{nd}”, “first”, and “second” may be used to express corresponding elements, it is not intended to limit the corresponding elements. When a certain (e.g., 1^{st}) element is mentioned as being “operatively or communicatively coupled with/to” or “connected to” a different (e.g., 2^{nd}) element, the certain element is directly coupled with/to another element or can be coupled with/to the different element via another (e.g., 3rd) element.

An expression “configured to” used in the present disclosure may be interchangeably used with, for example, “suitable for”, “having the capacity to”, “adapted to”, “made to”, “capable of”, or “designed to” in a hardware, software or any combination thereof, manner according to a situation. In a certain situation, an expressed “a device configured to” may imply that the device is “capable of” together with other devices or components. For example, “a processor configured to perform A, B, and C” may refer, for example, and without limitation, to a dedicated processor (e.g., an embedded processor) for performing a corresponding operation and/or a generic-purpose processor (e.g., Central Processing Unit (CPU) or an application processor) capable of performing corresponding operations by executing one or more software programs stored in a memory device, or the like.

An electronic device according to various embodiments of the present disclosure, for example, may include at least one of a smartphone, a tablet personal computer (PC), a mobile phone, a video phone, an electronic book (e-book) reader, a desktop PC, a laptop PC, a netbook computer, a workstation, a server, a personal digital assistant (PDA), a portable multimedia player (PMP), an MP3 player, a mobile medical appliance, a camera, and a wearable device (e.g., smart glasses, a head-mounted-device (HMD), electronic clothes, an electronic bracelet, an electronic necklace, an electronic appcessory, an electronic tattoo, a smart mirror, or a smart watch), or the like, but is not limited thereto.

According to some embodiments, the electronic device (ex. home appliance) may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a media box (e.g., Samsung HomeSync™ Apple TV™, or Google TV™), a game console (e.g., Xbox™ and PlayStation™), an electronic dictionary, an electronic key, a camcorder, and an electronic photo frame, or the like, but is not limited thereto.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.), or the like, but is not limited thereto.

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter), or the like, but is not limited thereto. The electronic device according to various embodiments of the present disclosure may be a combination of one or more of the aforementioned various devices. The electronic device according to some embodiments of the present disclosure may be a flexible (foldable) device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

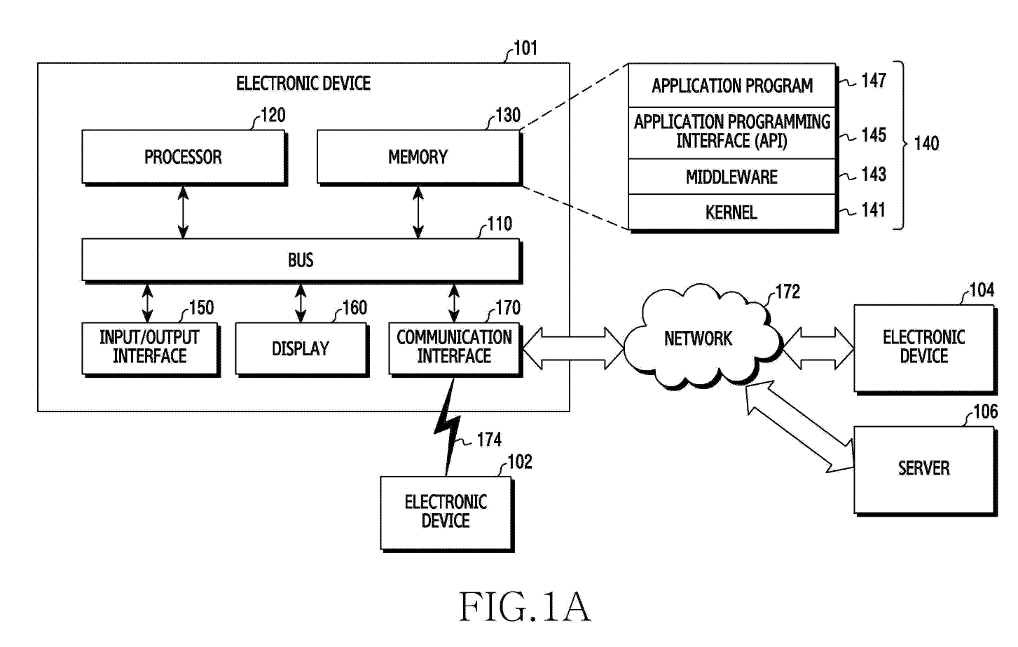

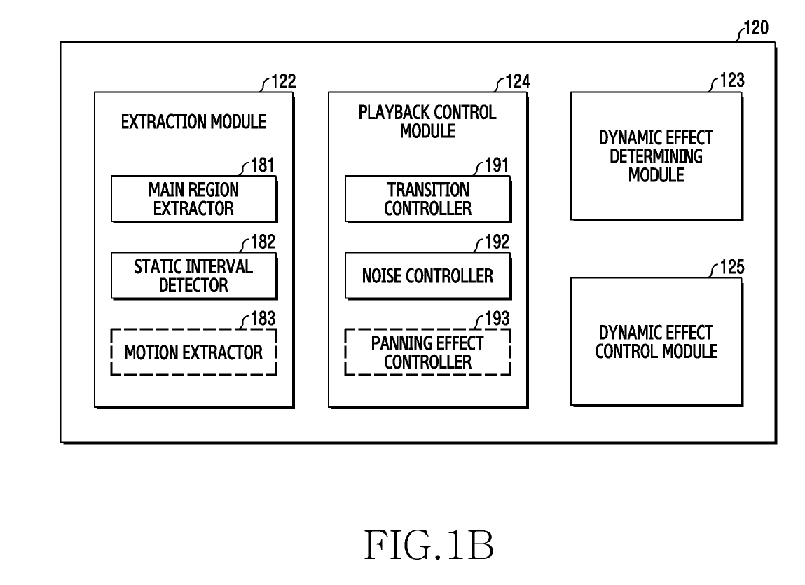

FIG. 1A is a diagram illustrating an electronic device 101 in a network environment according to various embodiments.

Referring to FIG. 1A, the electronic device 101 may include a bus 110, a processor (e.g., including processing circuitry) 120, a memory 130, an input/output (I/O) interface (e.g., including input/output interface circuitry) 150, a display 160, and a communication interface (e.g., including communication circuitry) 170. In another embodiment, the electronic device 101 may not include at least one of the components or may additionally include other components.

The bus 110, for example, may include a circuit that connects the components (120 to 170) and transmits signals (for example, control messages and/or data) among the components.

The processor 120 may include various processing circuitry, such as, for example, and without limitation, one or more of a dedicated processor, a Central Processing Unit (CPU), an Application Processor (AP), a Communication Processor (CP), and/or an Image Signal Processor (ISP), or the like. The processor 120, for example, can perform calculation or data processing about control and/or communication of one or more other components of the electronic device 101.

According to an embodiment, the processor 120 may identify at least one static interval to apply a dynamic effect in a video file that can be played back. For example, the processor 120 may analyze a similarity between a series of image frames (video frames) included in the video file. For example, the processor 120 may compare property values between the image frames to analyze the similarity between the image frames. The processor 120 may set the series of image frames, of which the similarity between the image frames is greater than or equal to a reference value, as the static interval. For example, the processor 120 may extract a Region Of Interest (ROI) from a saliency map of at least one image frame included in the static interval. The processor 120 may set the ROI of the image frame as a main region for applying the dynamic effect. For example, the processor 120 may create the saliency map of the image frame using a deep learning scheme (e.g., a Convolutional Neural Network (CNN), or the like, but is not limited thereto). For example, the processor 120 may set at least part of the at least one image frame included in the video file as the main region. The processor 120 may analyze a similarity of the main region between the series of image frames. For example, the processor 120 may compare at least one of a center coordinate, size, and location of the main region between the image frames to analyze the similarly of the main region between the image frames. The processor 120 may set the series of image frames, of which the similarity between the image frames is greater than or equal to the reference value, as the static interval. For example, the processor 120 may set a main interval based on face information or focus information detected from the image frame.

According to an embodiment, the processor 120 may determine a playback mode to be applied to the static interval. For example, the processor 120 may divide the series of image frames included in the video file into a plurality of shots. For example, the static interval may include at least one shot of which a similarity between image frames is greater than or equal to a reference value among the plurality of shots. The processor 120 may determine a playback pattern of the static interval based on at least one of a main region (e.g., a size and a location) in the image frame, a length of the static interval, and a global motion. The processor 120 may determine at least one playback mode to be applied to the static interval based on at least one of a probability model and a shot transition history. For example, the probability model of the playback mode may include a transition probability between playback modes according to a pattern (e.g., an order) of applying a dynamic effect. For example, the probability model of the playback mode may be set by a user or may be set by a pattern of applying a dynamic effect used by a specific person (e.g., a movie director). For example, the processor 120 may receive the pattern of applying the dynamic effect used by the specific person from an external device (e.g., a server). For example, when there is no history of applying the dynamic effect, the probability model of the playback mode may be randomly set or may be set by the user. When the history of applying the dynamic effect is accumulated, the processor 120 may update the transition probability of the playback mode based on the history of applying the dynamic effect. For example, in order to decrease the number of times of using a playback mode which is used relatively many times, the processor 120 may decrease a probability for transitioning to the playback mode. For example, the playback mode may include at least one of zoom-in, zoom-out, fade-in, fade-out, and panning. For example, the shot may include a series of image frames captured concurrently in a basic capture unit.

According to an embodiment, when a video file is played back, the processor 120 may apply a dynamic effect corresponding to at least one playback mode during the static interval of the video file. For example, upon detecting an irregular frame in the static interval, the processor 120 may limitedly apply the dynamic effect to the irregular frame. For example, at the occurrence of shot transition by applying the dynamic effect to the static interval, the processor 120 may provide control to minimize shaking of a window region displayed to the display 160 with respect to a time axis. For example, the processor 120 may collect a center coordinate of a main region or a coordinate of the main region in an interval to which the shot transition is applied, and thus may apply smoothing to compensate for the shaking of the window region when the shot transition occurs. For example, the window region may include at least part of the display 160 on which information of the video file is displayed.

According to an embodiment, the processor 120 may provide control to apply a panning effect based on a shot length. For example, when the shot length is relatively long and a size of the main region is relatively great, the processor 120 may control the display 160 to apply the panning effect in order to provide dynamics.

According to an embodiment, when the video file is played back, the processor 120 may apply the dynamic effect to the static interval on a real time basis. For example, when the video file is played back, the processor 120 may detect the static interval by analyzing a image frame to be played back after a specific time elapses from a playback time of the video file. The processor 120 may apply at least one dynamic effect to the static interval while playing back the picture. For example, upon detecting the static interval while playing back the video file, the processor 120 may control the display 160 to display an object corresponding to the dynamic effect. The processor 120 may apply the dynamic effect to the static interval based on an input of selecting the object corresponding to the dynamic effect. For example, upon completion of the playback of the video file, the processor 120 may control the memory 130 to store shot information of the video file. For example, the shot information of the video file may include at least one dynamic interval included in the video file and dynamic effect information (e.g., a playback mode) applied to each static interval.

The memory 130 may include a volatile and/or nonvolatile memory. For example, the memory 130 may store instructions or data related to at least one different components of the electronic device 101. According to an embodiment, the memory 130 may store at least one video file that can be played back in the electronic device 101. For example, the memory 130 may store the shot information of the video file in a metadata format of the video file.

According to an embodiment, the memory 130 may store a software and/or a program 140. For example, the program 140 may include a kernel 141, a middleware 143, an Application Programming Interface (API) 145, or an application program (or “application”) 147. At least some of the kernel 141, the middleware 143, and the API 145 may be referred to as an Operating System (OS).

For example, the kernel 141 may control or manage system resources (e.g., the bus 110, the processor 120, the memory 130, etc.) used to execute an operation or function implemented in other programs (e.g., the middleware 143, the API 145, or the application program 147). In addition, the kernel 141 may also provide an interface capable of controlling or managing system resources by accessing individual components of the electronic device 101 in the middleware 143, the API 145, or the application program 147.

For example, the middleware 143 may play an intermediary role so that the API 145 or the application program 147 exchange data by communicating with the kernel 141. In addition, the middleware 143 may also handle one or more task requests received from the application program 147 according to a priority. For example, the middleware 143 may handle one or more task requests by assigning a priority that can be used in a system resource (e.g., the bus 110, the processor 120, the memory 130, etc.) of the electronic device 101 to at least one of the application programs 147. As an interface used by the application program 147 to control a function provided from the kernel 141 or the middleware 143, the API 145 may include, for example, at least one interface or function (e.g., command) for file control, window control, image processing, text control, or the like.

The input/output interface 150 may include various input/output circuitry and serve as an interface through which commands or data input from a user or a different external device can be delivered to different component(s) of the electronic device 101. For example, the input/output interface 150 may include various input/output circuitry, such as, for example, and without limitation, at least one physical button such as a home button, a power button, a volume control button, or the like. For example, the input/output interface 150 may also include a speaker for outputting an audio signal and a microphone for collecting the audio signal.

The display 160 may display a variety of content (e.g., text, image, video, icon, and/or symbol, etc.) to the user. For example, the display unit 160 may include a Liquid Crystal Display (LCD), a Light Emitting Diode (LED) display, an Organic Light-Emitting Diode (OLED) display, a Micro Electro Mechanical System (MEMS) display, or an electronic paper display, or the like, but is not limited thereto.

According to an embodiment, the display 160 may include a display panel and a touch panel. For example, the display 160 may receive a touch, gesture, proximity, or hovering input using an electronic pen or a portion of a user's body through the touch panel. For example, the display panel and the touch panel may overlap entirely or at least partially. For example, the display 160 may further include a pressure panel. For example, the display 160 may receive a pressure input caused by a portion of the user's body or an object through the pressure panel. For example, the display panel, the touch panel, and the pressure panel may overlap entirely or at least partially.

The communication interface 170 may include various communication circuitry and establish communication between the electronic device 101 and an external device (e.g., the first external electronic device 102, the second external electronic device 104, or the server 106). For example, the communication interface 170 may be coupled to the network 172 through wireless or wired communication to communicate with the external device (e.g., the second external electronic device 104 or the server 106).

According to an embodiment, the wireless communication may include cellular communication using at least one of LTE, LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. According to an embodiment, as illustrated by the element 174 of FIG. 1 for example, the wireless communication may include short-distance communication 174 using at least one of Wireless Fidelity (WiFi), Bluetooth, Bluetooth Low Energy (BLE), Zigbee, Near Field Communication (NFC), magnetic secure transmission, Radio Frequency (RF), and Body Area Network (BAN). According to an embodiment, the wireless communication may include a Global Navigation Satellite System (GNSS). For example, the GNSS may be a Global Positioning System (GPS), a Global Navigation Satellite System (Glonass), a Beidou Navigation Satellite System (or Beidou), or the European global satellite-based navigation system (or Galileo). Hereinafter, the “GPS” and the “GNSS” may be interchangeably used in the present disclosure. According to an embodiment, the wired communication may include at least one of Universal Serial Bus (USB), High Definition Multimedia Interface (HDMI), Recommended Standard-232 (RS-232), power-line communication, Plain Old Telephone Service (POTS), and the like. The network 172 may include at least one of a telecommunications network, e.g., a computer network (e.g., LAN or WAN), the Internet, and a telephone network.

Each of the first and second external electronic devices 102 and 104 may be identical or different types of device with respect to the electronic device 101. According to various embodiments, all or some parts of operations performed in the electronic device 101 may be performed in one or a plurality of different electronic devices (e.g., the electronic devices 102 and 104, or the server 106).

FIG. 1B is a block diagram illustrating an example of the processor for applying a dynamic effect in an electronic device according to various embodiments of the present disclosure.

Referring to FIG. 1B, the processor 120 of FIG. 1A may include, for example, and without limitation, an extraction module (e.g., including processing circuitry and/or program elements) 122, a dynamic effect determining module (e.g., including processing circuitry and/or program elements) 123, a playback control module (e.g., including processing circuitry and/or program elements) 124, and a dynamic effect control module (e.g., including processing circuitry and/or program elements) 125.

According to an embodiment, the extraction module 122 may include a main region extractor (e.g., including processing circuitry and/or program elements) 181, a static interval detector (e.g., including processing circuitry and/or program elements) 182, and a motion extractor (e.g., including processing circuitry and/or program elements) 183. For example, the motion extractor 183 may be omitted.

According to an embodiment, the main region extractor 181 may include various processing circuitry and/or program elements and analyze at least one image frame in a video file to set a main region. For example, the main region extractor 181 may create a saliency map of the image frame using a deep learning scheme. The main region extractor 181 may set an ROI extracted using the saliency map as a main region of the image frame. For example, the main region extractor 181 may perform face recognition on the image frame to identify whether a face of an object exists in the image frame. The main region extractor 181 may set the main region such that a region recognized as the face is included in the image frame. For example, the main region extractor 181 may detect an object, of which a focus is set in the image frame, based on focus information of the video file. The main region extractor 181 may set the main region to include the object of which the focus is set. For example, the main region extractor 181 may obtain the focus information of the video file from additional information (e.g., exif) of the video file stored in the memory 130. For example, the main region extractor 181 may set the main region using all image frames of the video file or image frames included in a specific interval.

According to an embodiment, the static interval detector 182 may include various processing circuitry and/or program elements and set at least one static interval in the video file by analyzing a similarity between the image frames included in the video file. For example, when there are N image frames in the video file, the static interval detector 182 may divide the N image frames into M shots. The static interval detector 182 may set at least one shot, of which a similarity between image frames is greater than or equal to a reference value among the M shots, as a static interval for applying a dynamic effect. For example, N may include a constant greater than M. For example, the static interval detector 182 may recognize an interval, in which a change width between the image frames in the video file exceeds a designated change width (e.g., a reference change width), as one shot. In this case, the static interval detector 182 may be controlled not to apply an additional dynamic effect to a corresponding shot. For example, the static interval detector 182 may detect a static interval based on an overall feature value change pattern of the image frame. For example, the static interval detector 182 may detect the static interval based on a change pattern of a main region between the image frame. The change pattern of the main region may be determined based on at least one of a center coordinate, size, and location of the main region in the image frame.

According to an embodiment, the motion extractor 183 may include various processing circuitry and/or program elements and detect an object movement or a global motion from the video file. For example, when the location of the main region is changed in a state where the remaining regions (background) other than the main region of the image frame have similar feature values and a feature value change of the main region is less than a reference value, the motion extractor 183 may identify that the object is moved within the image frame. That is, the motion extractor 183 may detect a movement of the object based on a location change of the main region. For example, the motion extractor 183 may detect a global motion based on an overall feature value change pattern of consecutive video patterns included in the video file. For example, the motion extractor 183 may detect one global motion corresponding to a change pattern of the feature value when the change pattern of the feature value of the image frame is consistent.

According to an embodiment, the dynamic effect determining module 123 may include various processing circuitry and/or program elements and determine a playback mode of the static interval included in the video file. For example, the dynamic effect determining module 123 may determine at least one playback mode to be applied to the static interval based on at least one of the size and location of the main region of the image frame included in the static interval, a length of the static interval, a global motion, a playback pattern of the video file, a probability model, and a shot transition history. For example, the dynamic effect determining module 123 may determine at least one playback mode to be applied to the static interval based on a probability model and a type (e.g., a playback mode) of a shot disposed prior to the static interval. For example, when the dynamic effect determining module 123 identifies the playback mode to be applied to the static interval, a probability of transitioning to a corresponding playback mode may be decreased.

According to an embodiment, the playback control module 124 may include a transition controller (e.g., including processing circuitry and/or program elements) 191, a noise controller (e.g., including processing circuitry and/or program elements) 192, and a panning effect controller (e.g., including processing circuitry and/or program elements) 193. For example, the panning effect controller 193 may be omitted.

According to an embodiment, the transition controller 191 may include various processing circuitry and/or program elements and apply path smoothing for natural transition between shots. For example, when transitioning the shot, the transition controller 191 may correct a coordinate of a main region based on a movement of the main region and movement information of an object to mitigate a change width between image frames.

According to an embodiment, the noise controller 192 may include various processing circuitry and/or program elements and provide control to apply the dynamic effect based on a noise included in the static interval. For example, upon detecting an irregular frame in the static interval, the noise controller 192 may decide the irregular frame as the noise. Accordingly, the noise controller 192 may limitedly apply the dynamic effect to the irregular frame. For example, the noise controller 192 may analyze a similarity of the main region between image frames included in the static interval. The noise controller 192 may decide a image frame, of which a similarity of a main region is rapidly changed (e.g., decreased), as the irregular frame. When a similarly between image frames disposed prior to or next to the irregular frame is higher than a reference similarity and a length of the irregular frame is shorter than a reference length, the noise controller 192 may decide the irregular frame as the noise. For example, the noise controller 192 may decide the irregular frame based on movement information detected through a movement detection sensor (e.g., a gyro sensor).

According to an embodiment, the panning effect controller 193 may include various processing circuitry and/or program elements and provide control to apply the panning effect based on a shot length and a size of the main region included in the image frame. For example, when a length of image frames included in one shot exceeds a designated length (e.g., a reference length) and when the size of the main region exceeds a designated size (e.g., a reference size), the panning effect controller 193 may control the display 160 to apply the panning effect in order to provide dynamics to a corresponding shot interval.

According to an embodiment, the dynamic effect control module 125 may include various processing circuitry and/or program elements and control the applying of the dynamic effect when transitioning the shot. For example, the dynamic effect control module 125 may transiently add a transition effect such as a zoom effect (e.g., zoom-in or zoom-out) or a fading effect (e.g., fade-in or fade-out) when transitioning the shot. The dynamic effect control module 125 may determine a image frame to apply the transition effect based on a feature (e.g., a length and a similarity) of two adjacent shots. For example, the dynamic effect control module 125 may determine a image frame for introducing the transition effect in a previous shot and a image frame for ending the transition effect in the transitioned shot.

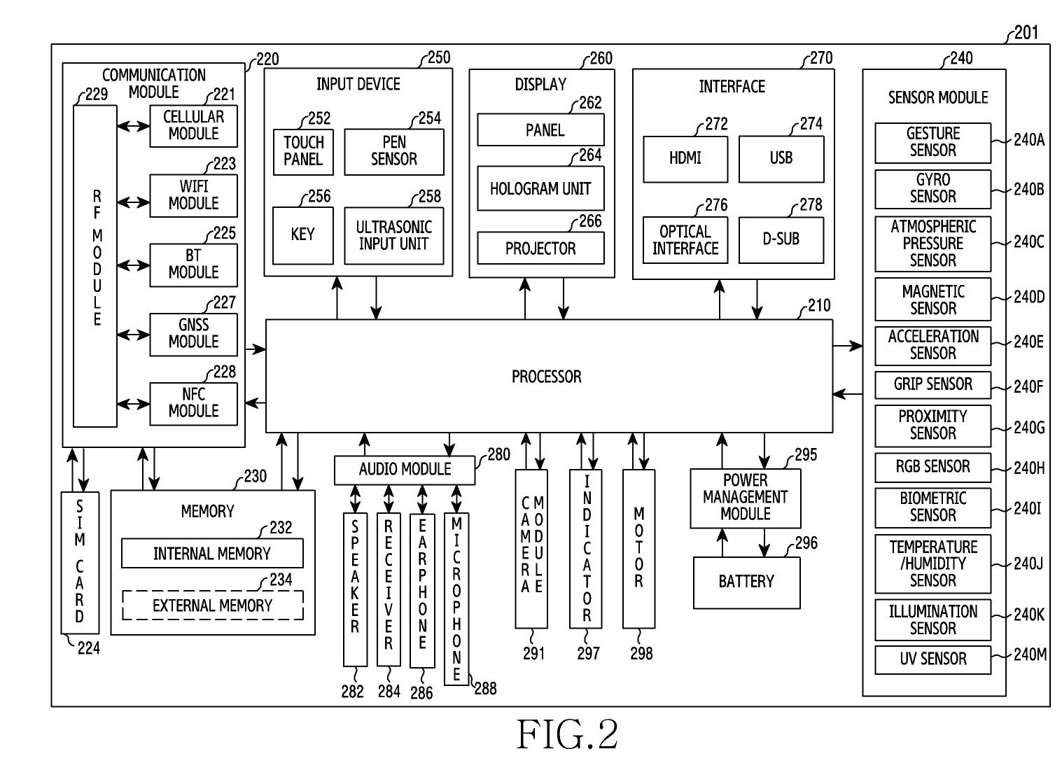

FIG. 2 is a block diagram illustrating an electronic device 201 according to various embodiments. The electronic device 201, for example, may include the entire or a portion of the electronic device 101 illustrated in FIG. 1A. The electronic device 201 may include one or more processors (e.g., including processing circuitry) 210 (for example, AP), a communication module (e.g., including communication circuitry) 220, a subscriber identification module 224, a memory 230, a sensor module 240, an input device (e.g., including input circuitry) 250, a display 260, an interface (e.g., including interface circuitry) 270, an audio module 280, a camera module 291, a power management module 295, a battery 296, an indicator 297, and a motor 298.

The processor 210, may include various processing circuitry that, for example, can control a plurality of hardware or software components connected to the processor 210 by operating an operating system or an application and can perform processing and calculation on various data. The processor 210, for example, may be a System on Chip (SoC). According to an embodiment, the processor 210 may further include a Graphic Processing Unit (GPU) and/or an Image Signal Processor (ISP). The processor 210 may include at least some (a cellular module 221) of the components shown in FIG. 2. The processor 210 can load and process commands or data received from other components (for example, a nonvolatile memory) on a volatile memory and can store the resultant data on a nonvolatile memory.

The communication module 220 may have a configuration the same as or similar to that of the communication interface 170 shown in FIG. 1A. The communication module 220, may include various modules that may include various communication circuitry, such as, for example, and without limitation, the communication circuitry may include a cellular module 221, an WiFi module 223, a Bluetooth module 225, an GNSS module 227, an NFC module 228, and an RF module 229.

The cellular module 221, for example, can provide a voice call, a video call, a text service, or an internet service through a communication network. According to an embodiment, the cellular module 221 can identify and authenticate the electronic device 201 in a communication network, using a subscriber identification module 224 (for example, a SIM card). According to an embodiment, the cellular module 221 can perform at least some of the functions that the processor 210 can provide. According to an embodiment, the cellular module 221 may include a Communication Processor (CP).

According to another embodiment, at least some (for example, two or more) of the cellular module 221, WiFi module 223, Bluetooth module 225, GNSS module 227, and NFC module 228 may be included in one Integrated Chip (IC) or IC package.

The RF Module 229, for example, can transmit and receive communication signals (for example, RF signals). The RF module 229, for example, may include a transceiver, a Power Amp Module (PAM), a frequency filter, a Low Noise Amplifier (LNA), or an antenna. According to another embodiment, at least one of the cellular module 221, WiFi module 223, Bluetooth module 225, GNSS module 227, and NFC module 228 can transmit and receive RF signals through a separate RF module. The subscriber identification module 224, for example, may include a card including a subscriber identification module or an embedded SIM and may include unique identification information (for example, Integrated Circuit Card Identifier (ICCID) or subscriber information (for example, International Mobile Subscriber Identity (IMSI).

The memory 230 (for example, the memory 130 shown in FIG. 1A), for example, may include a built-in memory 232 and/or an external memory 234. The built-in memory 232, for example, may include at least one of a volatile memory (for example, a DRAM, an SRAM, or an SDRAM) and a nonvolatile memory (for example, a One Time Programmable ROM (OTPROM), a PROM, an EPROM, an EEPROM, a mask ROM, a flash ROM, a flash memory, a hard drive, or a Solid State Drive (SSD). The external memory 234 may include a flash drive, for example, a Compact Flash (CF), a Secure Digital (SD), a Micro-SD, a Mini-SD, an Extreme Digital (xD), a Multi-Media Card (MMC), or a memory stick. The external memory 234 can be functionally or physically connected to the electronic device 201 through various interfaces.

The sensor module 240, for example, can measure physical quantities or sense operation states of the electronic device 201 and can convert the measured or sensed information into electrical signals. The sensor module 240, for example, may include at least one of a gesture sensor 240A, a gyro sensor 240B, a barometer (e.g., atmospheric pressure) sensor 240C, a magnetic sensor 240D, an acceleration sensor 240E, a grip sensor 240F, a proximity sensor 240G, a color sensor 240H (for example, an RGB (red, green, blue) sensor), a biometric sensor 240I, a temperature/humidity sensor 240J, an illumination sensor 240K, and/or an Ultraviolet (UV) sensor 240M. Additionally or alternatively, the sensor module 240, for example, may include an e-nose sensor, an Electromyography (EMG) sensor, an Electroencephalogram (EEG) sensor, an Electro-cardiogram (ECG) sensor, an Infrared (IR) sensor, an iris sensor, and/or a fingerprint sensor. The sensor module 240 may further include a control circuit for controlling one or more sensors therein. In another embodiment, the electronic device 201 may further include a processor configured to control the sensor module 240, separately or as a part of the processor 210, whereby it is possible to control the sensor module 240 while the processor 210 is in a sleep state.

The input device 250, for example, may include various input circuitry, such as, for example, and without limitation, a touch panel 252, a (digital) pen sensor 254, a key 256, and/or an ultrasonic input device 258, or the like. The touch panel 252, for example, may use at least one of electrostatic, decompressing, infrared, and ultrasonic methods. The touch panel 252 may further include a control circuit. The touch panel 252 can provide a touch response (touch coordinates) to a user by further including a tactile layer. The (digital) pen sensor 254, for example, may include a recognition sheet that is a part of the touch panel or a separate part. The key 256, for example, may include a physical button, an optical button, or a keypad. The ultrasonic input device 258 can sense an ultrasonic wave generated from an input tool through a microphone (for example, a microphone 288) and find data corresponding to the sensed ultrasonic wave.

The display 260 (for example, display (160) shown in FIG. 1A) may include a panel 262, a hologram device 264, a projector 266, and/or a control circuit for controlling these components. The panel 262, for example, may be implemented to be flexible, transparent, or wearable. The panel 262 may be configured as one or modules together with the touch panel 252. According to an embodiment, the panel 262 may include a pressure sensor (for example, a force sensor) that can measure pressure information (for example, pressure coordinates and intensity of pressure) about a touch by a user. The pressure sensor may be integrated with the touch panel 252 or may be composed of one or more sensors separated from the touch panel 252. The panel 262 may include a fingerprint sensor capable of detecting fingerprint information (e.g., a fingerprint image) for a user's touch. The fingerprint sensor may be implemented integrally with the touch panel 252, or may be implemented by one or more sensors separate from the touch panel 252. The hologram device 264 can show 3D images in the air, using interference of light. The projector 266 can show images by projecting light to a screen. The screen, for example, may be positioned inside or outside the electronic device 201.

The interface 270, for example, may include various interface circuitry, such as, for example, and without limitation, an HDMI 272, a USB 274, an optical interface 276, and/or a D-subminiature (D-sub) 278, or the like. The interface 270, for example, may be included in the communication interface 170 shown in FIG. 1A. Additionally or alternatively, the interface 270, for example, may include a Mobile High-definition Link (MHL) interface, an SD card/Multi-Media Card (MMC) interface, or an interface under Infrared Data Association (IrDA).

The audio module 280, for example, can convert a sound into an electrical signal and vice versa. At least some components of the audio module 280, for example, may be included in the I/O interface 150 shown in FIG. 1A. The audio module 280, for example, can process sound information input or output through a speaker 282, a receiver 284, an earphone 286, or a microphone 288. The camera module 291, for example, is a device that can take still images and moving images, and according to an embodiment, the camera module 291 may include one or more image sensors (for example, front sensors or rear sensors), lenses, ISPs, or flashes (for example, LEDs or xenon lamps). The power management module 295, for example, can manage power of the electronic device 201. According to an embodiment, the power management module 295 may include a Power Management Integrated Circuit (PMIC), a charging IC, or a battery or fuel gauge. The PMIC may have a wire and/or wireless charging method. The wireless charging method, for example, includes a magnetic resonance method, a magnetic induction method, or an electromagnetic wave method, and may further include an additional circuit for wireless charging, for example, a coil loop, a resonant circuit, or a rectifier. The battery gauge, for example, can measure the remaining capacity, or a voltage, a current, or temperature in charging of a battery 296. The battery 296, for example, may include a chargeable battery and/or a solar battery.

The indicator 297 can show specific statuses such as a booting status, a message status, or a charging status of the electronic device 201 or some (for example, the processor 210) of the electronic device 201. The motor 298 can convert electrical signals into mechanical vibration and can generate vibration or a haptic effect. The electronic device 201, for example, may include a mobile TV support device (for example, a GPU) that can process media data following standards such as Digital Multimedia Broadcasting (DMB), Digital Video Broadcasting (DVB), or mediaFlo™. The components described herein each may be composed of one or more elements and the names of the parts may depend on the kinds of electronic devices. In various embodiments, an electronic device (for example, the electronic device 201) may not include some of the components, may further include additional components, or may be configured as one part by combining some of the components, and can perform the functions of the components before combining.

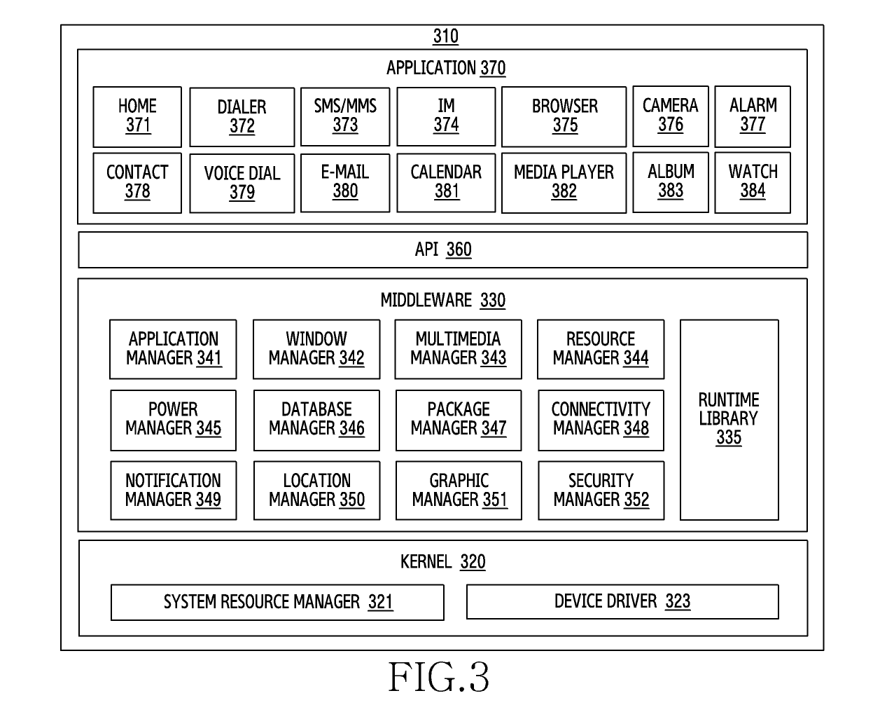

FIG. 3 is a block diagram illustrating a program module according to various embodiments. According to an embodiment, a program module 310 (for example, the program 140 shown in FIG. 1A) may include an operating system, which controls resources related to an electronic device (for example, the electronic device 101 shown in FIG. 1A), and/or various applications (for example, the application program 147 shown in FIG. 1A) that are executed on an operating system. The operating system, for example, may include Android™, iOS™, Windows™, Symbian™ Tizen™, or Bada™.

Referring to FIG. 3, a program module 310 may include a kernel 320 (for example, the kernel 141 shown in FIG. 1A), a middleware 330 (for example, the middleware 143 shown in FIG. 1A), an API 360 (for example, the API 145 shown in FIG. 1A), and/or an application 370 (for example, the application program 147 shown in FIG. 1A). At least a portion of the program module 310 can be pre-loaded on an electronic device or can be downloaded from an external electronic device (for example, the electronic devices 102 and 104 and the server 106 shown in FIG. 1A).

The kernel 320, for example, may include a system resource manager 321 and/or a device driver 323. The system resource manager 321 can control, allocate, or recover system resources. According to an embodiment, the system resource manager 321 may include a process manager, a memory manager, or a file system manager. The device driver 323, for example, may include a display driver, a camera driver, a Bluetooth driver, a shared memory driver, a USB driver, a keypad driver, a WiFi driver, an audio driver, a touch device driver, a pressure device driver, or an Inter-Process Communication (IPC) driver.

The middleware 330, for example, can provide functions that all of the applications 370 need, or can provide various functions to the applications 370 through the API 360 so that the application 370 can use limited system resources of an electronic device. According to an embodiment, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335, for example, may include a library module that is used by a compiler to add new functions, using a programming language while the application 370 is executed. The runtime library 335 can perform input/output management, memory management, or calculation function processing. The application manager 341, for example, can manage the lifecycle of the application 370. The window manager 342 can manage a GUI resource that is used for the screen. The multimedia manager 343 can find the formats for playing media files and encode or decode the media files, using codecs corresponding to the formats. The resource manager 344 can manage the source code of the application 370 or the space of a memory. The power manager 345, for example, can manage the temperature of a battery, the capacity of a battery or power and provide power information for operating an electronic device. According to an embodiment, the power manager 345 can operate together with a Basic Input/Output System (BIOS). The database manager 346, for example, can create, search for, or change a database to be used by the application 370. The package manager 347 can manage installation or update of applications that are released in the type of a package file.

The connectivity manager 348, for example, can manage wireless connection. The notification manager 349, for example, can provide events such as an arrived message, a promise, and notification of proximity to a user. The location manager 350, for example, can manage the location information of an electronic device. The graphic manager 351, for example, can manage a graphic effect to be provided to a user or a user interface related to the graphic effect. According to an embodiment, when an object is detected from an image displayed on the display 160, the graphic manager 351 can manage a graphic effect displaying detection information corresponding to the configuration information of the object.

The security manager 352, for example, can provide system security or user authentication. According to an embodiment, the middleware 330 may include a telephony manager for managing a voice or video call function of an electronic device or a middleware module that can generate combinations of the functions of the components described above. According to an embodiment, the middleware 330 can provide modules specified for the kinds of operating systems. The middleware 330 can dynamically delete some of existing component or add new components. The API 360, for example, may be provided to have different configurations, depending on operating systems, as a set of API programming functions. For example, for Android™ or iOS™, one API set can be provided for each platform, and for Tizen™, two or more API sets can be provided for each platform.

The application 370, for example, may include home 371, dialer 372, SMS/MMS 373, Instant Message (IM) 374, browser 375, camera 376, alarm 377, contact 378, voice dial 379, email 380, calendar 381, medial player 382, album 383, and/or watch 384. Additionally, though not shown, the applications may include various other applications, such as, for example, and without limitation, healthcare (for example, measuring the amount of exercise or blood sugar), or environment information (for example, atmospheric pressure, humidity, or temperature information) providing applications. According to an embodiment, the application 370 may include an information exchange application that can support information exchange between an electronic device and an external electronic device. The information exchange application, for example, may include a notification relay application for transmitting specific information to an external electronic device or a device management application for managing an external electronic device. For example, a notification transmission application can transmit notification information generated by another application of an electronic device to an external electronic device, or can receive notification information from an external electronic device and provide the notification information to a user. The device management application, for example, can install, delete, or update the functions of an external electronic device communicating with an electronic device (for example, turning-on/off of the external electronic device (or some components) or adjustment of brightness (or resolution) of a display), or an application that is executed in an external electronic device. According to an embodiment, the application 370 may include an application designated in accordance with the property of an external electronic device (for example, a healthcare application of a mobile medical device). According to an embodiment, the application 370 may include an application received from an external electronic device. At least a portion of the program module 310 can be implemented (for example, executed) in software, firmware, hardware (for example, the processor 210), or a combination of at least two of them, and may include a module, a program, a routine, an instruction set, or a process for performing one or more functions.

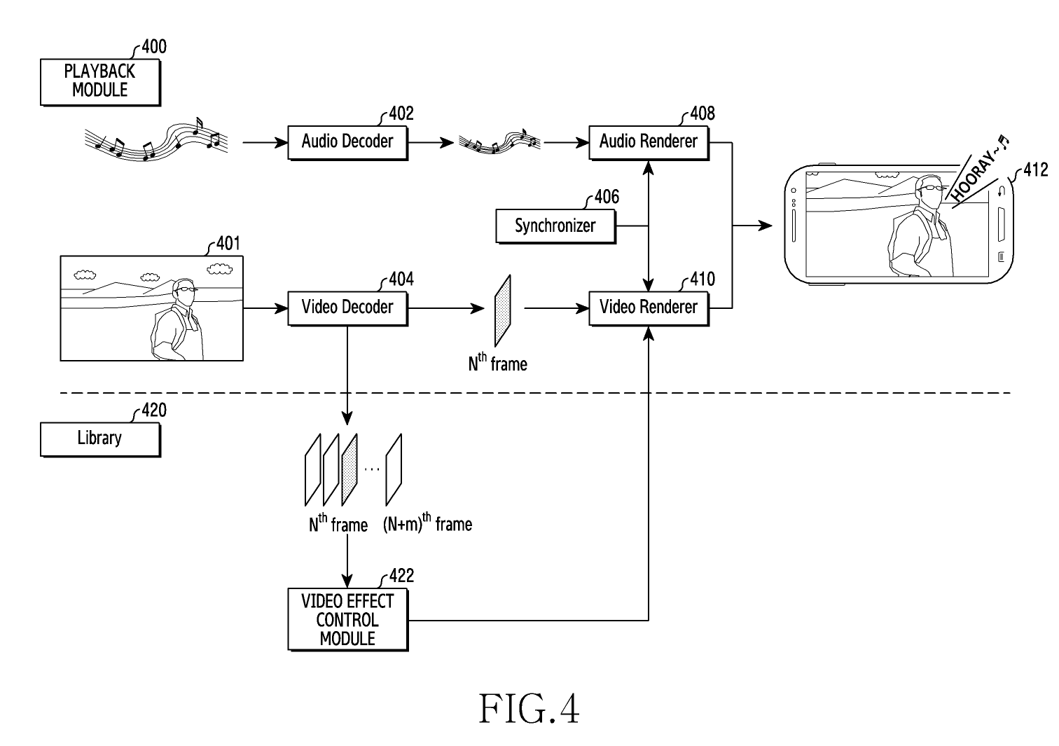

FIG. 4 is a diagram illustrating a structure for applying a dynamic effect when a picture is played back in an electronic device according to various embodiments of the present disclosure.

Referring to FIG. 4, the electronic device may play back a video file using a playback module (e.g., including playback circuitry) 400. For example, the playback module 400 may play back an audio signal of the video file using an audio decoder (e.g., including audio decoding circuitry) 402 and an audio renderer (e.g., including audio rendering circuitry) 408. For example, the audio decoder 402 may decode the audio signal encoded in the video file based on at least one coding scheme (e.g., Digital Theater Systems (DTS), Advanced Audio Coding (AAC), etc.). The audio renderer 408 may render the audio signal decoded by the audio decoder 402 so as to correspond to an audio signal output pattern of the video file. For example, the playback module 400 may play back a image frame 401 of the video file using a video decoder 404 and a video renderer 410. For example, the video decoder 404 may decode the image frame encoded in the video file based on at least one encoding scheme (e.g., Moving Picture Experts Group (MPEG), Advanced Video Coding (AVC), etc.). The video renderer 410 may render the image frame decoded by the video decoder 402 so as to correspond to a playback pattern of the video file provided from a library 420. For example, the playback module 400 may synchronize and output the audio signal and image frame rendered by the audio renderer 408 and video renderer 410 through a synchronizer 406 (see, e.g., 412). For example, the playback module 400 may include an application for playing back the picture.

According to an embodiment, the library 420 may provide control to apply the dynamic effect to the static interval through a video effect control module 422. For example, the video effect control module 422 may analyze the image frame decoded in the video decoder 404 to detect at least one static interval. The video effect control module 422 may determine a playback mode for applying the dynamic effect to at least one static interval. The video effect control module 422 may create a playback pattern of the video file based on the playback mode of the static interval. For example, the video effect control module 422 may analyze the image frame to be rendered later by a specific period of time (e.g., 2 seconds) than a image frame being rendered by the video renderer 410 to decide whether the dynamic effect is applied. For example, the video effect control module 422 may include the extraction module 122, dynamic effect determining module 123, playback control module 124, and dynamic effect control module 125 illustrated in FIG. 1B. For example, the video effect control module 422 may be included in the middleware 330 of FIG. 3.

According to various embodiments of the present disclosure, an electronic device may include a memory, a display, and a processor. The processor may be configured to identify an amount of change between one or more image frames stored in the memory, to detect at least one image frame among the one or more image frames based on the amount of change, to determine a partial region from an entire region of the at least one image frame, determine a playback mode corresponding to the partial region, and to display the partial region based on the playback mode using the display.

According to various embodiments, the processor may be configured to determine the partial region based on at least one of: a saliency map, facial recognition information, or focus setting information of the one or more image frames.

According to various embodiments, the processor may be configured to determine the playback mode to change a zoom ratio for the partial region based on a display size of the partial region.

According to various embodiments, the processor may be configured to determine the playback mode to perform panning on at least part of the one or more image frames based on the amount of change.

According to various embodiments, the processor may be configured to store the playback mode as association information related to the one or more image frames.

According to various embodiments, if the amount of change satisfies a designated condition, the processor may be configured to display a user interface including information indicating that the playback mode can be changed, using the display.

According to various embodiments, the processor may be configured to receive an input corresponding to the displayed user interface, and to play back the one or more image frames in the playback mode based at least on the reception of the input.

According to various embodiments, if the one or more image frames are played back, the processor may be configured to identify an amount of change between image frames to be played back later by a designated time (e.g., a reference time) than an image frame being played back.

According to various embodiments of the present disclosure, an electronic device may include a memory, a display, and a processor. The processor may be configured to determine a partial region in one or more image frames stored in the memory, identify an amount of change of the partial region between the one or more image frames, to detect at least one image frame among the one or more image frames based on the amount of change, to determine a playback mode corresponding to the partial region of the at least one image frame, and to display the partial region based on the playback mode using the display.

According to various embodiments, the processor may be configured to determine the partial region based on at least one of: a saliency map, facial recognition information, or focus setting information of the one or more image frames.

According to various embodiments, the processor may be configured to determine the playback mode to change a zoom ratio for the partial region based on a display size of the partial region.

According to various embodiments, if the amount of change is less than a designated condition, the processor may be configured to determine a playback mode corresponding to the partial region.

According to various embodiments, if the amount of change satisfies a designated condition, the processor may be configured to display a user interface including information indicating that the playback mode can be changed, using the display.

According to various embodiments, if the amount of change satisfies a designated condition, the processor may be configured to receive an input corresponding to the displayed user interface, and to play back the one or more image frames in the playback mode based on the reception of the input.

According to various embodiments, if the one or more image frames are played back, the processor may be configured to identify an amount of change between image frames to be played back later by a designated time than an image frame being played back.

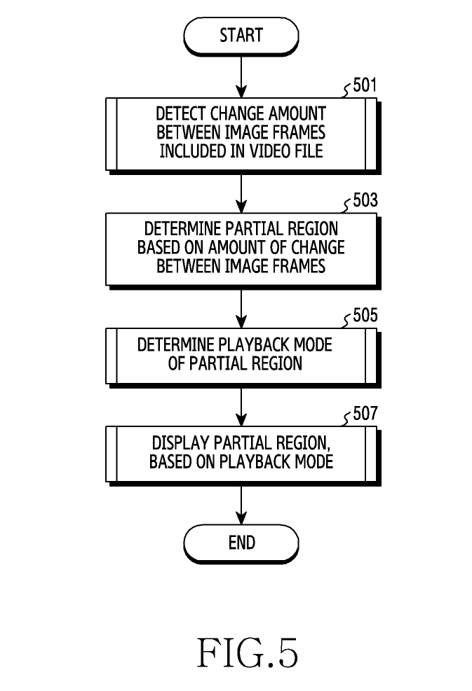

FIG. 5 is a flowchart illustrating an example of applying a dynamic effect in an electronic device according to various embodiments of the present disclosure. In the following description, the electronic device may include the electronic device 101 of FIG. 1A or at least part (e.g., the processor 120) of the electronic device 101.

Referring to FIG. 5, in operation 501, the electronic device may detect a change amount between image frames included in a video file to be played back in the electronic device. For example, the processor 120 may select the video file to be played back from a video file list stored in the memory 130 based on a user input. The processor 120 may detect a similarity between image frames by comparing a feature value between a series of image frames included in the video file to be played back. That is, the processor 120 may detect the similarity between the image frames by sequentially comparing a feature value between adjacent image frames included in the video file.

In operation 503, the electronic device may determine a partial region from an entire region of at least one image frame detected based on the change amount between the image frames. For example, the processor 120 may identify whether there is a series of image frames (a static interval), of which a similarity between image frames is greater than or equal to a reference value, in the video file. In the presence of the image frames (the static interval) of which the similarity between the image frames is greater than or equal to the reference value, the processor 120 may decide that the dynamic effect is applicable to at least part of the video file. In this case, the processor 120 may set the partial region from the entire region of the image frame as a main region for applying the dynamic effect. For example, the processor 120 may analyze the at least one image frame included in the static interval to create a saliency map. For example, the saliency map of the image frame may be created using a CNN scheme. The processor 120 may extract an ROI from the saliency map of the image frame. The processor 120 may set the ROI which is at least part of the image frame as the main region for applying the dynamic effect. For example, the processor 120 may set the main region to include a region in which a face is recognized in the image frame. For example, the processor 120 may set the main region to include an object of which a focus is set in the image frame. For example, the processor 120 may set the main region by analyzing all image frames included in the static interval or image frames having a specific interval.

In operation 505, the electronic device may determine at least one playback mode to apply the dynamic effect to the partial region. For example, the processor 120 may determine at least one playback mode to be applied to the main region of the static interval based on at least one of a size and location of the main region, a length of the static interval, a global motion, and a shot transition history and probability model of the electronic device 101. For example, the processor 120 may determine at least one playback mode to be applied to the static interval based on a playback mode used prior to the static interval and a transition probability corresponding to the playback mode. For example, in the absence of the shot transition history, the playback mode to be applied to the static interval may be determined based on any probability model. The processor 120 may update the probability model for determining the playback mode by analyzing an overall playback pattern of the video file.

In operation 507, the electronic device may display the partial region of at least one image frame to a display based on at least one playback mode. For example, the processor 120 may apply the dynamic effect to the static interval by playing back the video file based on the at least one playback mode. For example, the processor 120 may provide control not to apply the dynamic effect to an irregular frame so that the shot is naturally transitioned in the video file. The processor 120 may correct a coordinate of the main region based on a movement of the main region and movement information of an object to minimize shaking of a window region displayed to the display according to the shot transition.

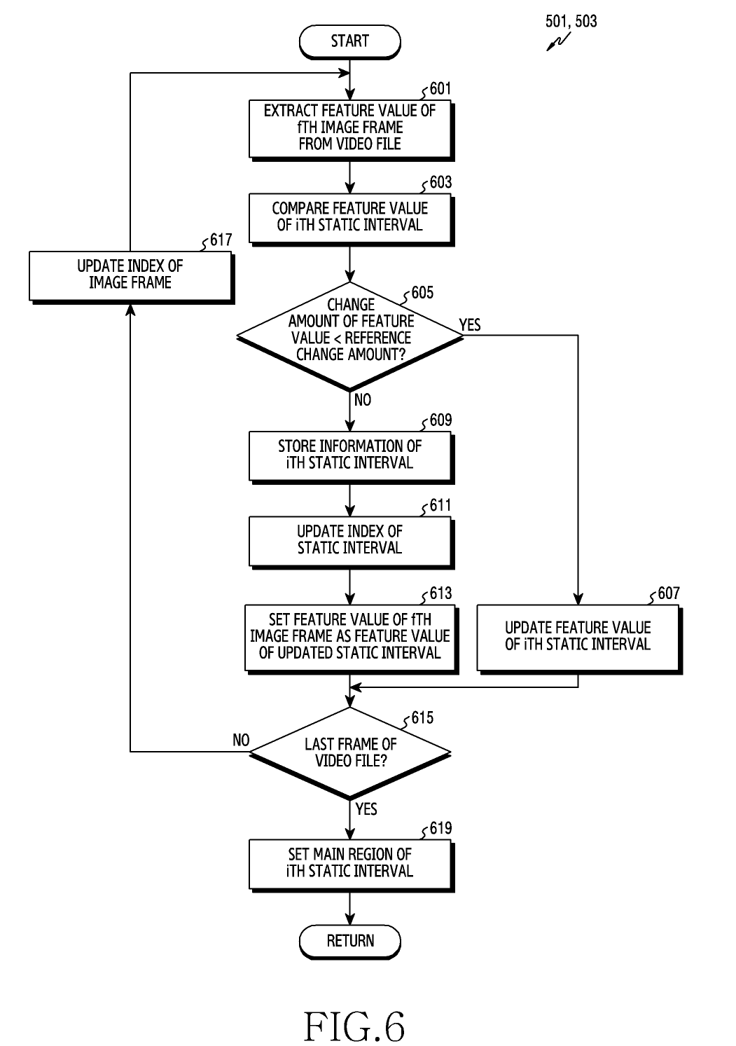

FIG. 6 is a flowchart illustrating an example of setting a static interval in an electronic device according to various embodiments of the present disclosure. Hereinafter, the operation for setting the static interval in operations 501 to 503 of FIG. 5 is described. In the following description, the electronic device may include the electronic device 101 of FIG. 1A or at least part (e.g., the processor 120) of the electronic device 101. Hereinafter, an operation of detecting a static interval by analyzing a video file before the playback of the video file in the electronic device is described.

Referring to FIG. 6, in operation 601, the electronic device may extract a feature value of an f^{th} image frame from the video file to be played back in the electronic device. For example, f denotes an index of a image frame included in the video file, and an initial value thereof may be set to 0.

In operation 603, the electronic device may compare a feature value of an i^{th} static interval and a feature value of the f^{th} image frame in the video file. For example, the processor 120 may compare an average of feature values of at least one image frame included in the i^{th} static interval and the feature value of the f^{th} image frame extracted in operation 601. For example, i denotes an index of a static interval included in the video file, and an initial value thereof may be set to 0.

In step 605, the electronic device may determine whether a change amount of feature values of the f^{th} image frame and the i^{th} static interval is less than a designated change amount (e.g., a reference change amount) based on a result of comparing feature values of the f^{th} image frame and the i^{th} static interval.

In operation 607, if the change amount of the feature values of the f^{th} image frame and the i^{th} static interval is less than the designated change amount, the electronic device may update the feature value of the i^{th} static interval. For example, if the change amount of the feature value of the f^{th} image frame and the i^{th} static interval is less than the designated change amount, the processor 120 may decide that the f^{th} image frame is included in the i^{th} static interval. Accordingly, the processor 120 may update an average feature value of the i^{th} static interval based on the feature value of the f^{th} image frame.

In operation 615, the electronic device may determine whether the f^{th} image frame is a last image frame included in the video file.

In operation 609, if the change amount of the feature value of the f^{th} image frame and the i^{th} static interval is greater than or equal to the designated change amount, the electronic device may store information of the i^{th} static interval. For example, if the change amount of the feature value of the f^{th} image frame and the i^{th} static interval is greater than or equal to the designated change amount, the processor 120 may decide that the f^{th} image frame is not included in the i^{th} static interval. Accordingly, the processor 120 may control the memory 130 to store a image frame list included in the i^{th} static interval.

In operation 611, the electronic device may update an index of the static interval. For example, the processor 120 may update the index of the static interval (e.g., i++) to identify whether there is a static interval different from the static interval in the video file.

In operation 613, the electronic device may set the feature value of the f^{th} image frame as the feature value of the static interval including the updated index. For example, since up to an (f−1)^{th} image frame is included in the i^{th} static interval, the processor 120 may identify that the f^{th} image frame is included in a next static interval. Accordingly, the processor 120 may set the feature value of the f^{th} image frame as the average feature value of the static interval of the updated index.

In operation 615, the electronic device may identify whether the f^{th} image frame is the last image frame included in the video file. For example, the processor 120 may identify whether the index of the f^{th} image frame corresponds to a maximum index of the image frame included in the video file.

In operation 617, if the f^{th} image frame is not the last image frame included in the video file, the electronic device may update the index of the image frame. For example, the processor 120 may update the index of the image frame (e.g., f++) to identify whether there is a image frame included in the static interval among other image frames included in the video file.

In operation 619, if the f^{th} image frame is the last image frame included in the video file, the electronic device may set a main region for applying a dynamic effect in the static interval. For example, the processor 120 may set at least one main region to apply the dynamic effect using a saliency map of the image frame included in the static interval. For example, the processor 120 may set at least one main region to include a region in which a face is detected in the image frame included in the static interval. For example, the processor 120 may set at least one main region to include a region of which a focus is set in the image frame included in the static interval.

According to an embodiment, if the f^{th} image frame is the last image frame included in the video file, the electronic device may remove the updated static interval including the f^{th} image frame from the static interval list of the video file. For example, the static interval may include a series of image frames of which a similarity between the image frames is greater than or equal to a reference value. Accordingly, a static interval of an updated index including only the f^{th} image frame cannot be set as the static interval of the video file.

According to an embodiment, if the f^{th} image frame is the last image frame included in the video file, the electronic device may store at least one static interval information detected from the video file in a memory as information related to the video file. For example, the memory 130 may store static interval information of the video file in a metadata format.

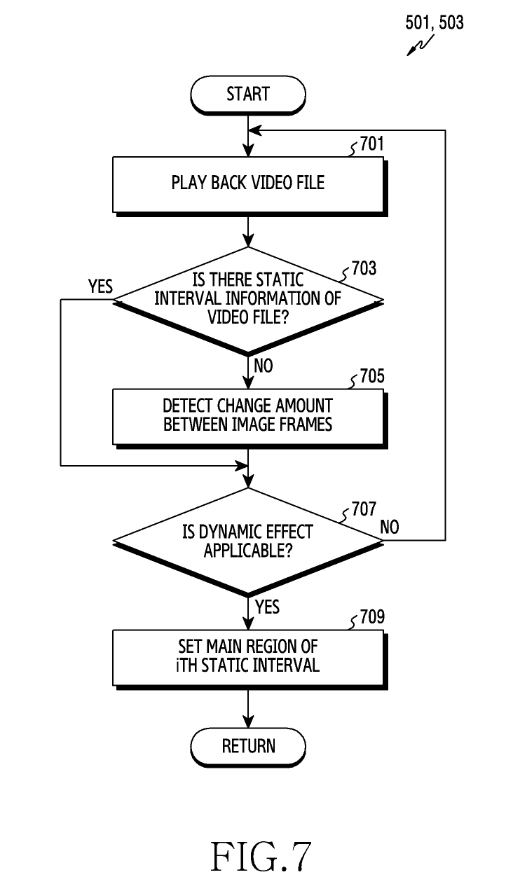

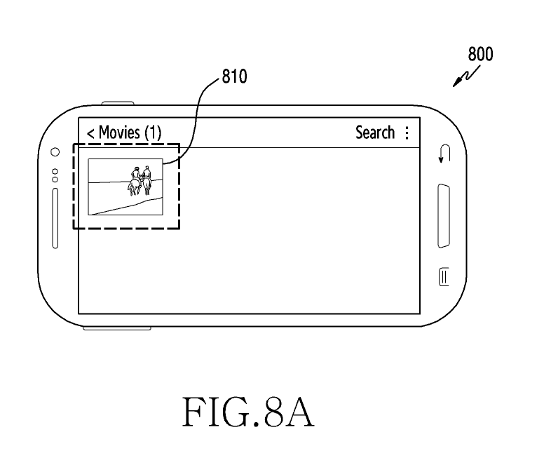

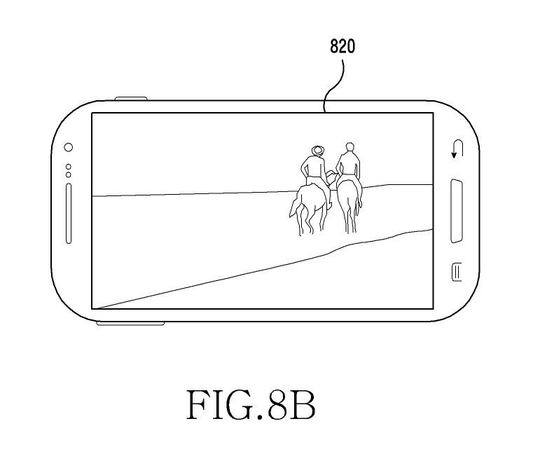

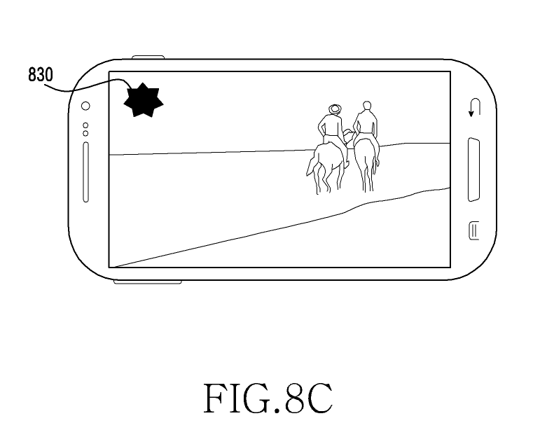

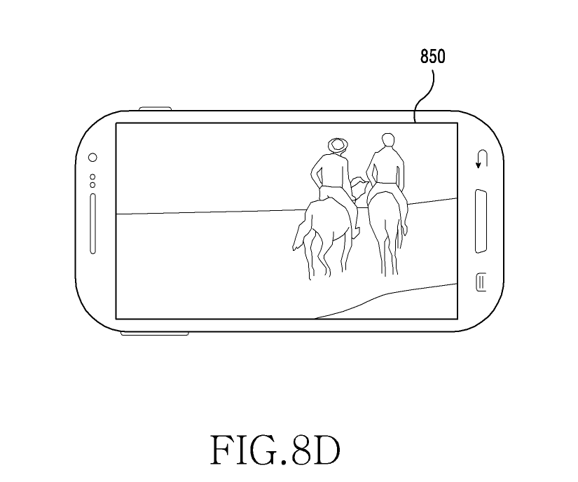

FIG. 7 is a flowchart illustrating an example of applying a dynamic effect when a picture is played back in an electronic device according to various embodiments of the present disclosure. FIGS. 8A, 8B, 8C and FIG. 8D are diagrams illustrating example screen configurations for applying a dynamic effect in an electronic device according to various embodiments of the present disclosure. Hereinafter, the operation for setting the static interval in operations 501 to 503 of FIG. 5 is described. In the following description, the electronic device may include the electronic device 101 of FIG. 1A or at least part (e.g., the processor 120) of the electronic device 101. Hereinafter, an operation of detecting a static interval while a video file is played back in the electronic device is described.

Referring to FIG. 7, in operation 701, the electronic device may play back the video file. For example, upon detecting occurrence of an event for playing back the video file, as illustrated in FIG. 8A, the processor 120 may control the display 160 to display a service screen 800 of an application (e.g., a gallery application) for playing back the video file. For example, the service screen 800 of the application may include a list 810 of video files stored in the memory 130. The processor 120 may play back the video file corresponding to a user input in the video file list 810. For example, as illustrated in FIG. 8B, the processor 120 may control the display 160 to display a playback screen 820 of the video file corresponding to the user input.

In operation 703, the electronic device may determine whether there is static interval information corresponding to the video file. For example, the processor 120 may identify whether the static interval information corresponding to the video file being played back is stored in the memory 130. For example, the static interval information corresponding to the video file may be detected before the playback of the video file as in operations 601 to 617 of FIG. 6 or may be detected at a previous playback time of the video file.

In the presence of the static interval information corresponding to the video file, in operation 707, the electronic device may determine whether a dynamic effect is applicable to a video file being displayed based on the static interval information corresponding to the video file. For example, the processor 120 may determine whether a image frame to be played back later by a specific time (e.g., 2 seconds) than the image frame being played back in the video file is included in the static interval.

In operation 705, in the absence of the static interval information corresponding to the video file, the electronic device may detect a change amount between image frames of the video file. For example, the processor 120 may detect a change amount of image frames to be played back later by a specific time (e.g., 2 seconds) than the image frame being played back in the image frame.

In operation 707, the electronic device may determine whether the dynamic effect is applicable to the video file based on the change amount between the image frames. For example, if a change amount of image frames to be played back later by a specific time (e.g., 2 seconds) than the image frame being played back in the video file is less than a designated change amount (e.g., a reference change amount), the processor 120 may set a series of image frames having a change amount less than the designated change amount as a static interval for applying the dynamic effect.

If the dynamic effect is not applicable to the video file, in operation 701, the electronic device may persistently play back the video file.

In operation 709, if the dynamic effect is applicable to the video file, the electronic device may set a main region to apply the dynamic effect to the static interval. For example, the processor 120 may set at least one main region to apply the dynamic effect based on at least one of a saliency map, face recognition information, and focus information of the image frame included in the static interval.

According to an embodiment, upon determining that the image frame to be played back later by a specific time than the image frame being played back is included in the static interval, the electronic device may determine a playback mode of the image frame to be played back. For example, the processor 120 may determine the playback mode of the image frame before a playback time of the image frame included in the static interval (e.g., operations 505 to 507 of FIG. 5) arrives.

According to an embodiment, if the dynamic effect is applicable to the video file, the electronic device may display a user interface corresponding to the dynamic effect to at least some regions of the video file being played back. For example, when the image frame included in the static interval is rendered and then played back, as illustrated in FIG. 8C, the processor 120 may control the display 160 to display an object 830 corresponding to the dynamic effect to at least part of the video file being played back. For example, upon detecting a selection input (e.g., a touch input) of the object 830 corresponding to the dynamic effect, as illustrated in FIG. 8D, the processor 120 may apply the dynamic effect to a main region based on a playback mode (e.g., a zoom-in mode) corresponding to the image frame (see, e.g., 850).

According to an embodiment, when the dynamic effect is applied to at least one static interval while the video file is being played back, the electronic device may store information of at least one static interval detected from the video file as information related to the video file. For example, the memory 130 may store static interval information of the video file in a metadata format. For example, when the video file is completely played back and the dynamic effect is given to all shots included in the video file, the processor 120 may store information of applying the dynamic effect as the information related to the video file.

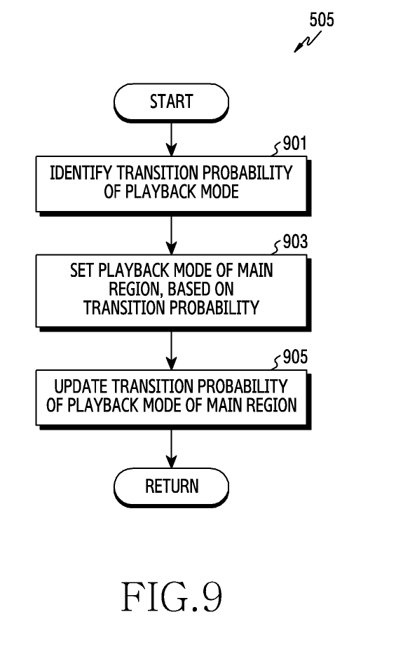

FIG. 9 is a flowchart illustrating an example of determining a playback mode of a static interval in an electronic device according to various embodiments of the present disclosure. Hereinafter, an operation of determining a playback mode of a main region in operation 505 of FIG. 5 is described. In the following description, the electronic device may include the electronic device 101 of FIG. 1A or at least part (e.g., the processor 120) of the electronic device 101.

Referring to FIG. 9, in operation 901, upon setting the main region for applying the dynamic effect in the static interval (e.g., operation 503 of FIG. 5), the electronic device may identify a transition probability of at least one playback mode applicable to the static interval. For example, the transition probability of the playback mode may be set by a user or may be determined based on a shot transition history and a probability model received from a server. For example, the probability mode set by the user or received from the server may be updated based on the shot transition history.

In operation 903, the electronic device may set at least one playback mode to be applied to a main region of a static interval based on the transition probability of at least one playback mode applicable to the static interval. For example, the processor 120 may determine at least one playback mode to be applied to the static interval based on a playback mode used prior to the static interval and the transition probability corresponding to the playback mode. For example, in the absence of the playback mode used prior to the static interval, the processor 120 may determine the playback mode to be applied to the static interval based on a probability model which is randomly set.

In operation 905, the electronic device may update a transition probability of at least one playback mode which is set to be applied to the main region of the static interval. For example, if a specific playback mode is frequently selected as the playback mode to be applied to the static interval, the playback of the static interval may become monotonous. Accordingly, the processor 120 may decrease the transition probability of at least one playback mode selected to be applied to the static interval.

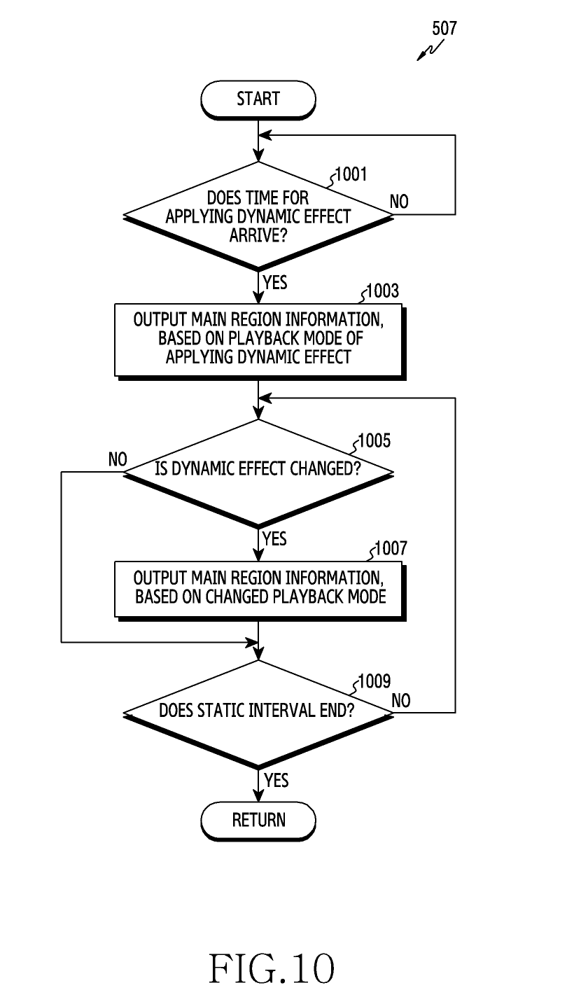

FIG. 10 is a flowchart illustrating an example of applying a dynamic effect based on a playback mode in an electronic device according to various embodiments of the present disclosure. Hereinafter, the operation for applying a dynamic effect to a static interval in operation 507 of FIG. 5 is described. In the following description, the electronic device may include the electronic device 101 of FIG. 1A or at least part (e.g., the processor 120) of the electronic device 101.

Referring to FIG. 10, in operation 1001, upon determining at least one playback mode to be applied to the static interval (e.g., operation 505 of FIG. 5), the electronic device may determine whether a time for applying the dynamic effect arrives. For example, upon playing back the video file, the processor 120 may identify whether a playback time of a image frame included in the static interval for applying the dynamic effect arrives. For example, as illustrated in FIG. 8C, the processor 120 may identify whether a selection input (e.g., a touch input) corresponding to the dynamic effect displayed to at least part of the video file being played back is detected.

In operation 1003, when the time for applying the dynamic effect arrives, the electronic device may output main region information based on a playback mode of the time for applying it. For example, the processor 120 may control the display 160 to display a main region of an image frame based on a playback mode corresponding to a image frame being played back. For example, the processor 120 may control the display 160 to display the main region in a zoom-in manner in the image frame being played back. For example, a zoom-in ratio of the main region may be set based on a size of the main region.

In operation 1005, the electronic device may determine whether to change the dynamic effect to be applied to the static interval. For example, when a plurality of playback modes are set in the static interval, the processor 120 may identify whether a time of applying another playback mode arrives.

Upon maintaining the dynamic effect to be applied to the static interval, in operation 1009, the electronic device may determine whether the static interval ends.

In operation 1007, upon deciding to change the dynamic effect to be applied to the static interval, the electronic device may output main region information based on the changed playback mode. For example, upon changing the playback mode to be applied to the static interval, the processor 120 may control the display 160 to update the display of the main region displayed to the display 160 so as to correspond to the changed playback mode.

In operation 1009, the electronic device may determine whether the static interval ends.

When the image frame included in the static interval is played back, in operation 1005, the electronic device may determine again whether to change the dynamic effect to be applied to the static interval.

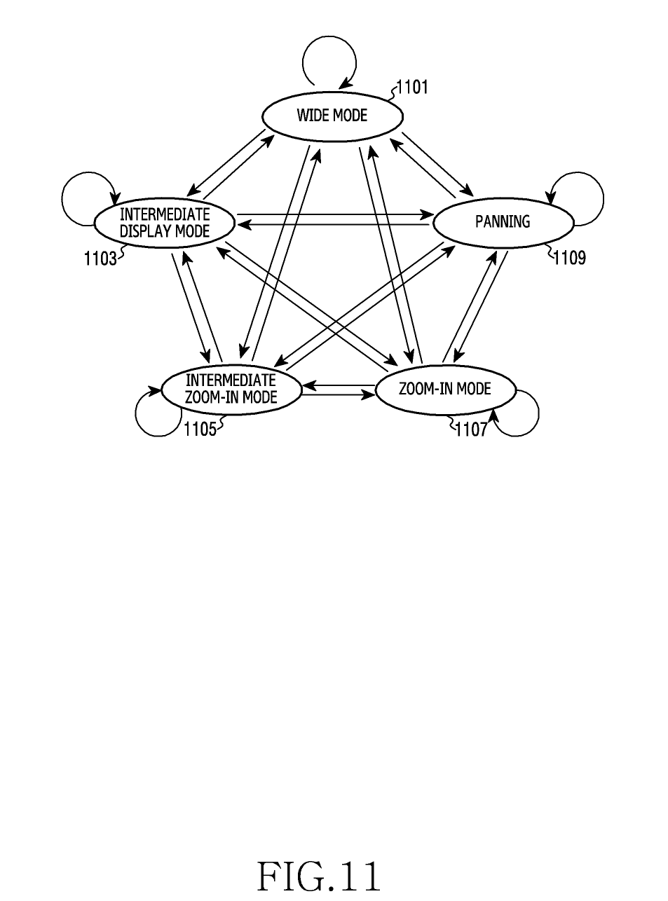

FIG. 11 is a state transition diagram illustrating an example of transitioning a playback mode applicable to a static interval in an electronic device according to various embodiments of the present disclosure.

According to an embodiment, the electronic device may divide a shot type using a wide mode 1101, an intermediate display mode 1103, an intermediate zoom-in mode 1105, and a zoom-in mode 1007 based on a size of a main region of a image frame for applying the dynamic effect. For example, the electronic device may additionally provide a panning mode 1109 for applying a panning effect based on a shot length. For example, the wide mode 1101, the intermediate display mode 1103, the intermediate zoom-in mode 1105, and the zoom-in mode 1007 may sequentially correspond to a size of the main region. For example, a main region corresponding to the wide mode 1101 may have a largest size, and a main region corresponding to the zoom-in mode 1107 may have a smallest size.

According to an embodiment, the electronic device may determine a playback mode of the static interval so as to transition from each shot type to the same shot type or a different shot type based on a probability model.

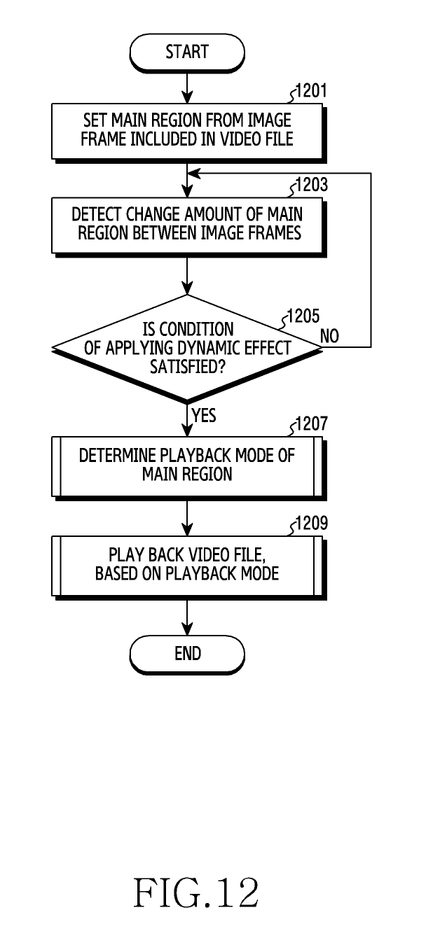

FIG. 12 is a flowchart illustrating an example of applying a dynamic effect based on a change amount (e.g., an amount of change) of a main region in an electronic device according to various embodiments of the present disclosure. In the following description, the electronic device may include the electronic device 101 of FIG. 1A or at least part (e.g., the processor 120) of the electronic device 101.

Referring to FIG. 12, in operation 1201, the electronic device may set a main region in a image frame included in a video file to be played back in the electronic device. For example, the processor 120 may set an ROI of the image frame using a saliency map of the image frame created through CNN. The processor 120 may set the ROI of the image frame as a main region for applying a dynamic effect. For example, the processor 120 may set a main interval to include a face object detected within the image frame through a face recognition algorithm. For example, the processor 120 may acquire focus information of the image frame from additional information (e.g., exif) of the video file. The processor 120 may set the main interval to include an object of which a focus is set in the image frame. For example, the processor 120 may set the main region by analyzing all image frames included in the video file or image frames having a specific interval.

In operation 1203, the electronic device may detect a change amount of the main region between the image frames included in the video file. For example, the processor 120 may compare a center coordinate, size, or location of the main region between the image frames to analyze the change amount of the main region between the image frames. The processor 120 may set a series of image frames, of which a change amount of a main region between image frames is greater than or equal to a reference value in the video file, as the static interval.

In operation 1205, the electronic device may determine whether the dynamic effect is applicable to at least part of the video file based on the change amount of the main region between the image frames. For example, the processor 120 may identify whether there is a series of image frames, of which a similarly of the main region between image frames is greater than or equal to a reference value, in the video file. For example, the processor 120 may identify the series of image frames, of which the similarity of the main region between the image frames is greater than or equal to the reference value, as the static interval.

In operation 1207, upon deciding that the dynamic effect is applicable to at least part of the video file, the electronic device may determine at least one playback mode for applying the dynamic effect to the main region. For example, as shown in operations 901 to 905 of FIG. 9, the processor 120 may determine at least one playback mode to be applied to the main region of the static interval based on a shot transition history and probability model of the electronic device 101.

In operation 1209, the electronic device may apply the dynamic effect to the static interval by playing back a picture based on at least one playback mode. For example, as shown in operations 1001 to 1009 of FIG. 10, the processor 120 may control the display 160 to display the main region of the image frame included in the static interval based on at least one playback mode which is set in the static interval.

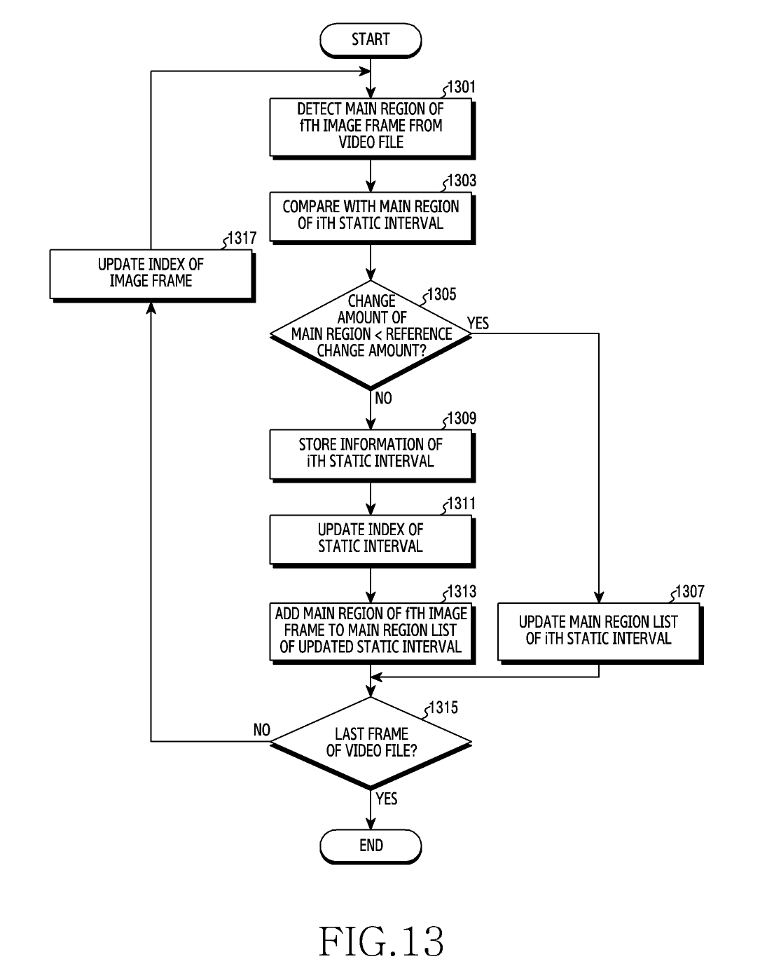

FIG. 13 is a flowchart illustrating an example of setting a static interval based on a change amount of a main region in an electronic device according to various embodiments of the present disclosure. Hereinafter, the operation for setting the static interval in operation 1203 of FIG. 12 is described. In the following description, the electronic device may include the electronic device 101 of FIG. 1A or at least part (e.g., the processor 120) of the electronic device 101. Hereinafter, an operation of detecting a static interval by analyzing a video file before the playback of the video file in the electronic device is described.

Referring to FIG. 13, in operation 1301, the electronic device may detect a main region of an f^{th} image frame from a video file to be played back in the electronic device. For example, the processor 120 may extract a size of a main region included in the f^{th} image frame, a center coordinate, and location information of the main region in the image frame. For example, f denotes an index of a image frame included in the video file, and an initial value thereof may be set to 0.

In operation 1303, the electronic device may compare main region information of an i^{th} static interval in the video file and main region information of the f^{th} image frame. For example, the processor 120 may compare an average of main region information of at least one image frame included in the i^{th} static interval and main region information of the f^{th} image frame extracted in operation 1301. For example, i denotes an index of a static interval included in the video file, and an initial value thereof may be set to 0.

In step 1305, the electronic device may determine whether a change amount of main regions of the f^{th} image frame and the i^{th} static interval is less than a designated change amount (e.g., a reference change amount) based on a result of comparing main region information of the f^{th} image frame and the i^{th} static interval.

In operation 1307, if the change amount of the main region of the f^{th} image frame and the i^{th} static interval is less than the designated change amount, the electronic device may update a main region list of the i^{th} static interval. For example, the processor 120 may add main region information of the f^{th} image frame to a main region list of image frames included in the i^{th} static interval.

In operation 1315, the electronic device may determine whether the f^{th} image frame is a last image frame included in the video file.

In operation 1309, when the change amount of the main regions of the f^{th} image frame and the i^{th} static interval is greater than or equal to the designated change amount, the electronic device may store information of the i^{th} static interval. For example, if the change amount of the main regions of the f^{th} image frame and the i^{th} static interval is greater than or equal to the designated change amount, the processor 120 may decide that the f^{th} image frame is not included in the i^{th} static interval. Accordingly, the processor 120 may control the memory 130 to store a image frame list included in the i^{th} static interval.

In operation 1311, the electronic device may update an index of the static interval. For example, the processor 120 may update the index of the static interval (e.g., i++) to identify whether there is a static interval different from the i^{th} static interval in the video file.

In operation 1313, the electronic device may add the main region information of the f^{th} image frame to the main region list of the static interval including the updated index. For example, since up to a main region of an (f−1)^{th} image frame is included in the main region list in the i^{th} static interval, the processor 120 may add the main region of the f^{th} image frame to a main region list of a next static interval.

In operation 1315, the electronic device may determine whether the f^{th} image frame is the last image frame included in the video file. For example, the processor 120 may identify whether the change of the main region is compared for all image frames included in the video file.

In operation 1317, if the f^{th} image frame is not the last image frame included in the video file, the electronic device may update the index of the image frame. For example, the processor 120 may update the index of the image frame (e.g., f++) to identify whether there is a image frame included in the static interval among other image frames included in the video file.

According to an embodiment, if the f^{th} image frame is the last image frame included in the video file, the electronic device may store at least one static interval information detected from the video file in a memory as information related to the video file. For example, the memory 130 may store static interval information of the video file in a metadata format.

According to an embodiment, the electronic device may detect a static interval to apply a dynamic effect by comparing a change amount of a main region between image frames to be played back later by a specific time (e.g., 2 seconds) than a image frame being played back while a video file is played back.

According to various embodiments of the present disclosure, a method of operating an electronic device may include identifying an amount of change between one or more images stored in a memory electrically coupled to the electronic device, detecting at least one image frame among the one or more image frames based on the amount of change, determining a partial region from an entire region of the at least one image frame, determining a playback mode corresponding to the partial region, and displaying the partial region based on the playback mode.

According to various embodiments, the determining of the playback mode may include determining the playback mode to change a zoom ratio for the partial region based on a display size of the partial region.

According to various embodiments, the determining of the playback mode may include determining the playback mode to perform panning on at least part of the one or more image frames based on the change amount

According to various embodiments, the method may further include storing the playback mode as association information related to the one or more image frames.

According to various embodiments, the method may further include, if the amount of change satisfies a designated condition, displaying a user interface including information indicating that the playback mode can be changed.

According to various embodiments, the displaying of the partial region may include receiving an input corresponding to the displayed user interface, and displaying a partial region of the one or more image frames in the playback mode based on the reception of the input.

According to various embodiments, the identifying of the amount of change may include, if the one or more image frames are played back, identifying an amount of change between image frames to be played back later by a designated time than an image frame being played back.

An electronic device and an operating method thereof according to various embodiments can improve user accessibility for a video file by applying at least one dynamic effect to a static interval when the video file is played back.

An electronic device and an operating method thereof according to various embodiments can naturally apply a dynamic effect in a video file by limitedly applying the dynamic effect to a image frame which is momentarily shaken and by minimizing a change in a window region to which the dynamic effect is applied, when at least one dynamic effect is applied to the static interval.

The term “module” used in the present disclosure may include a unit including at least of hardware, software, and/or firmware, or any combinations thereof, and may be interchangeably used with the term such as a logic, a logical block, a component, a circuit, or the like. The “module” may be a minimum unit of an integrally constituted component or may be a part thereof. The “module” may be mechanically or electrically implemented, and may include, for example, and without limitation, a dedicated processor, a CPU, an Application-Specific Integrated Circuit (ASIC) chip, a Field-Programmable Gate Arrays (FPGAs), and/or a programmable-logic device, or the like, which are known or will be developed and which perform certain operations.

At least some parts of a device (e.g., modules or functions thereof) or method (e.g., operations) according to various embodiments may be implemented with an instruction stored in a computer-readable storage medium (e.g., the memory 130). If the instruction is executed by a processor (e.g., the processor 120), the processor may perform a function corresponding to the instruction. The computer readable recording medium may include a hard disk, a floppy disk, magnetic media (e.g., a magnetic tape), optical media (e.g., a Compact Disc-ROM (CD-ROM), a Digital Versatile Disc (DVD), magnetic-optic media (e.g., a floptical disk)), an internal memory, or the like. The instruction may include a code created by a compiler or a code executable by an interpreter. The module or programming module according to various embodiments may further include at least one or more components among the aforementioned components, or may omit some of them, or may further include additional other components.

Operations performed by a module, programming module, or other components according to various embodiments may be executed in a sequential, parallel, repetitive, or heuristic manner. Further, some of the operations may be executed in a different order or may be omitted, or other operations may be added.

In addition, the various example embodiments illustrated in the present disclosure are provided for explaining and understanding technical features, not for limiting the scope of the present disclosure. Therefore, all changes based on the technical features of the present disclosure or various other embodiments will be understood as being included in the scope of the present disclosure.

What is claimed is:

1. An electronic device comprising:
a memory;
a display; and
a processor,
wherein the processor is configured to:
detect an amount of change between one or more image frames stored in the memory;
detect at least one image frame among the one or more image frames based on the amount of change;
determine a partial region from an entire region of the at least one image frame;
determine a playback mode corresponding to the partial region; and
control the display to display the partial region based on the playback mode.

2. The electronic device of claim 1, wherein the processor is configured to determine the partial region based on at least one of: a saliency map, facial recognition information, or focus setting information of the one or more image frames.

3. The electronic device of claim 1, wherein the processor is configured to determine the playback mode to change a zoom ratio for the partial region based on a display size of the partial region.

4. The electronic device of claim 1, wherein the processor is configured to determine the playback mode to perform panning on at least part of the one or more image frames based on the amount of change.

5. The electronic device of claim 1, wherein the processor is configured to control the memory to store the playback mode as association information related to the one or more image frames.

6. The electronic device of claim 1, wherein, if the amount of change satisfies a designated condition, the processor is configured to control the display to display a user interface comprising information indicating that the playback mode can be changed.

7. The electronic device of claim 6, wherein the processor is configured to:
receive an input corresponding to the displayed user interface; and
play back the one or more image frames in the playback mode based on at least the received input.

8. The electronic device of claim 1, wherein, if the one or more image frames are played back, the processor is configured to detect an amount of change between image frames to be played back later by a designated time than an image frame being played back.

9. A method of operating an electronic device, the method comprising:
detecting an amount of change between one or more images stored in a memory electrically coupled to the electronic device;
detecting at least one image frame among the one or more image frames based on the amount of change;
determining a partial region from an entire region of the at least one image frame;
determining a playback mode corresponding to the partial region; and
displaying the partial region based on the playback mode.

10. The method of claim 9, wherein the determining of the playback mode comprises determining the playback mode to change a zoom ratio for the partial region based on a display size of the partial region.

11. The method of claim 9, wherein the determining of the playback mode comprises determining the playback mode to perform panning on at least part of the one or more image frames based on the change amount

12. The method of claim 9, further comprising storing the playback mode as association information related to the one or more image frames.

13. The method of claim 9, further comprising, if the amount of change satisfies a designated condition, displaying a user interface comprising information indicating that the playback mode can be changed.

14. The method of claim 13, wherein the displaying of the partial region comprises:
receiving an input corresponding to the displayed user interface; and
displaying a partial region of the one or more image frames in the playback mode based on at least based on the received input.

15. The method of claim 9, wherein the detecting of the amount of change comprises, if the one or more image frames are played back, identifying an amount of change between image frames to be played back later by a designated time than an image frame being played back.

16. An electronic device comprising:
a memory;
a display; and
a processor,
wherein the processor is configured to:
determine a partial region in the one or more image frames;
detect an amount of change of the partial region between one or more image frames stored in the memory;
detect at least one image frame among the one or more image frames based on the amount of change;
determine a playback mode corresponding to the partial region of the at least one image frame; and
control the display to display the partial region based on the playback mode.

17. The electronic device of claim 16, wherein the processor is configured to determine the partial region based on at least one of: a saliency map, facial recognition information, or focus setting information of the one or more image frames.

18. The electronic device of claim 16, wherein the processor is configured to determine the playback mode to change a zoom ratio for the partial region based on a display size of the partial region.

19. The electronic device of claim 16, wherein the processor is configured to:
if the amount of change satisfies a designated condition, control the display to display a user interface comprising information indicating that the playback mode can be changed;
receive an input corresponding to the displayed user interface; and
play back the one or more image frames in the playback mode based on at least the received input.

20. The electronic device of claim 16, wherein if the one or more image frames are played back, the processor is configured to detect an amount of change between image frames to be played back later by a designated time than an image frame being played back.
